(19) United States
(12) Patent Application Publication
(10) Pub. No.: US 2009/0205964 A1
(43) Pub. Date: Aug. 20, 2009

(54) ELECTROCHEMICAL SAMPLING HEAD OR ARRAY OF SAME

(75) Inventors: William Martin Holber, Winchester, MA (US); Mackenzie King, Southbury, CT (US); Peter C. Van Buskirk, Newtown, CT (US)

Correspondence Address: INTELLECTUAL PROPERTY / TECHNOLOGY LAW, PO BOX 14329, RESEARCH TRIANGLE PARK, NC, 27709, US

(73) Assignee: ADVANCED TECHNOLOGY MATERIALS, INC., Danbury, CT (US)

(21) Appl. No.: 12/305,652

(22) PCT Filed: Jun. 18, 2007
(86) PCT No.: PCT/US07/71458

§ 371 Date: Jan. 13, 2009

Related U.S. Application Data
(60) Provisional application No. 60/815,213, filed on Jun. 20, 2006.

(51) Int. Cl. G01N 27/416; C25D 21/12

(52) U.S. Cl. 205/81; 204/406

(57) ABSTRACT

A sampling head, and/or an array including same for use in electrochemical deposition of various metal(s) on wafers or other substrates suitable for use in microelectronic devices or components thereof.

### CROSS-REFERENCE TO RELATED APPLICATION

The benefit of priority of U.S. Provisional Patent Application No. 60/815,213 filed Jun. 20, 2006 in the names of William Holber, Mackenzie King and Peter Van Buskirk for “ELECTROCHEMICAL SAMPLING HEAD OR ARRAY OF SAME,” is hereby claimed under the provisions of 35 US 119.

### FIELD OF THE INVENTION

The present invention relates to defect analysis reduction tool technology as applied to the plating of wafers or other suitable substrates typically used for the formation of microelectronic devices and components thereof. The present invention in specific aspects relates to features added to the defect analysis reduction tool technology used for the plating of one or more of a variety of metals (e.g., copper, gold, cobalt, platinum or other suitable metal species, etc.) on a substrate. Results of the data analysis may be utilized to adjust, for example, plating bath compositions (e.g., concentrations of acid, chloride or other halide, accelerators, suppressors, and/or levelers, or replacement of a plating bath due to presence of too many impurities or by-products or based on the age of the bath) in order to increase the percentage of acceptable plated wafers having defects below a set threshold level. Typically, the electroplated wafers are used in the manufacture of various microelectronic devices and components.

### DESCRIPTION OF THE RELATED ART

Miniaturization of microelectronic devices is a well accepted trend. Such devices are also being re-designed, re-tooled or otherwise improved to provide better performance. This miniaturization (and/or improved performance) is due in part to electronic circuits being developed that have smaller and more defined features.

In the regime of microelectronic interconnect layers in the manufacture of semiconductor microelectronic devices, the use of aluminum (Al) as a metal layer for forming the interconnect layers has largely been replaced with copper (Cu) as the metal of choice for the most demanding applications. This is, in part, due to the fact that increasing signal speeds, performance demands, and/or decreasing feature geometries of microelectronics limits the usefulness of Al. Thus, the use of Al has been largely supplanted by the use of Cu. Copper deposition may be carried out in an electroplating bath. However, Cu deposition in an electroplating bath is prone to several problems which, if left uncorrected, lead to the formation of undesirably defective microelectronic devices or components.

While the description herein may be provided with respect to copper deposition via the use of an electroplating bath, the description may be applied to the deposition or plating of gold, cobalt, platinum, or other suitable metals or metal species.

It is well recognized that, left unchecked, Cu may deposit at too rapid a rate (e.g., depositing more quickly at the top of a feature than in the rest of the feature) in an electroplating bath leading to “necking” or the formation of bridging layers of Cu over vias, troughs and other features. Such “necking” and/or bridging leaves undesirable voids in and/or on the substrate or the deposited layer (or both).

It is therefore desirable to provide ways to avoid, reduce or minimize the formation of unwanted voids or other defects. In other words, it is desirable to control the deposition of Cu to proceed in such a fashion so as to reduce or minimize the occurrence of Cu plating defects to below an acceptable threshold level.

To overcome the excessively rapid deposition of Cu on and/or within microelectronic devices (or components and/or features thereof), a variety of additives including, but not limited to, suppressors, accelerators, levelers and the like may be added to a copper electroplating bath. These additives are provided to prevent, reduce, attenuate or otherwise improve the deposition (e.g., electroplating) of Cu on and/or within microelectronic devices (or components and/or features thereof) to make microelectronic devices and/or components with the desired performance characteristics—preferably in a more cost effective manner.

Levelers are organic (or other) compound(s) added to Cu electroplating baths that improve the filling of various microelectronic device features so that the roughness of the so filled layer is reduced and/or its flatness is improved.

Suppressors are organic (or other) compound(s) added to Cu electroplating baths that improve the filling of various microelectronic device features so that unwanted “necking” or bridging over vias, troughs and the like is reduced so that the proper Cu filling of the various microelectronic device features is achieved.

Accelerators are organic (or other) compound(s) added to Cu electroplating baths that also improve the filling of various microelectronic device features so that proper Cu filling of the various microelectronic device features is achieved. Typically, suppressors slow down the rate at which Cu is deposited via the use of Cu electroplating baths and accelerators have the opposite effect. Oftentimes, the proper combination of at least one accelerator together with at least one suppressor and/or at least one leveler is necessary to achieve the desired or proper Cu deposition on or within a microelectronic device or component.

However, the Cu deposition achieved by the combination of accelerator(s), suppressor(s) and/or leveler(s) is prone to wide variation because as the Cu deposition proceeds, a variety of by-products may be formed and/or the concentration of the accelerator(s), suppressor(s) and/or leveler(s) may be sufficiently changed to undesirably alter the deposition of Cu during the manufacture of microelectronic devices or components.

It has been recognized that if the proper control over the chemistry of the Cu electroplating bath could be achieved, fewer defective devices or components can be made which preferably reduces the associated waste and/or cost.

For numerous wet bath applications, there is a need for finer control of the bath chemistry. This is needed in order to meet the process requirements of more advanced semiconductor devices: linewidth, aspect ratio, and selectivity are some of the examples. Wet chemistries which require a greater degree of control include Chemical Mechanical Polishing (CMP), used to planarize dielectric and metal film layers, post-etch and/or post-CMP wet cleaning (used to remove residue left over from those processes, for example) and Electro-Chemical Plating (ECP) or Electro-Chemical Deposition (ECD) used to deposit metal layers both as blanket films and into high-aspect-ratio features. ECP and ECD may be used synonymously.

In current semiconductor fabrication facilities, the majority of both CMP and ECD processes are typically run open-loop in terms of process bath chemistries. That is, the bath chemistry is set by the mixture of chemicals, bath temperature, etc., without real-time feedback as to whether the chemistry has drifted from its intended values.

In some cases, samples are periodically taken from the bath and analyzed in an offline analytic instrument—that is, an instrument which is not part of the wafer-to-wafer process flow. If the sample shows that the chemistry has drifted, it is adjusted appropriately by adding chemicals or replacing the entire bath. One example of such an offline analytic instrument is the ATMI Defect Analysis Reduction Tool technology product. The ATMI Defect Analysis Reduction Tool technology product utilizes a technique called galvanostatic analysis to electrochemically analyze various constituents of the bath. Various patents and publications cover the major aspects of the technology underlying the Defect Analysis Reduction Tool technology product.

For example, a variety of techniques have been used to measure and/or control the composition of Cu (and/or other) electroplating baths. See, for example, U.S. Pat. Nos. 5,192,404; 6,280,602 (Method and Apparatus for Determination of Additives in Metal Plating Baths); U.S. Pat. No. 6,592,737 (Method and Apparatus for Determination of Additives in Metal Plating Baths); U.S. Pat. No. 6,495,011 (Apparatus for Determination of Additives in Metal Plating Baths); U.S. Pat. No. 6,709,568 (Method for Determining Concentrations of Additives in Acid Copper Electrochemical Deposition Baths); U.S. Pat. No. 6,936,157 (Interference Correction of Additives Concentration Measurements in Metal Electroplating Solutions); U.S. Pat. No. 6,758,955 (Methods for Determination of Additive Concentration in Metal Plating Baths); U.S. Pat. No. 6,913,686 (Methods for Analyzing Solder Plating Solutions); U.S. Pat. No. 6,844,196 (Analysis of Antioxidant in Solder Plating Solutions Using Molybdenum Dichloride Dioxide); U.S. Pat. No. 7,022,215 (System and Methods for Analyzing Copper Chemistry); and U.S. Pat. No. 6,758,960 (Electrode Assembly and Method of Using the Same); and U.S. Pat. No. 6,954,560 (Attenuated Total Reflection Spectroscopic Analysis of Organic Additives in Metal Plating Solutions). Each of the foregoing listed U.S. Pat. Nos. is incorporated herein by reference in its entirety for all purposes.

See also U.S. Patent Applications having Ser. Nos. 11/135,311 (Methods and Apparatuses for Analyzing Solder Plating Solutions); Ser. No. 10/233,943 (Electrochemical Analytical Apparatus and Method of Using the Same); Ser. No. 10/658,948 (Sampling Management for a Process Analysis Tool to Minimize Sample Usage and Decrease Sampling Time); Ser. No. 10/314,776 (Plating Bath Composition and Control); Ser. No. 10/672,433 (Electrode Assembly for Analysis of Metal Electroplating Solution, Comprising Self-Cleaning Mechanism, Plating Optimization Mechanism, and/or Voltage Limiting Mechanism); Ser. No. 10/320,876 (Process Analyzer for Monitoring Electrochemical Deposition Solutions); Ser. No. 10/722,174 (On-Wafer Electrochemical Deposition Plating Metrology Process and Apparatus); Ser. No. 10/833,193 (Methods for Analyzing Inorganic Components of an Electrolytic Solution, and/or Cleaning an Electrochemical Analytical Cell); Ser. No. 10/838,390 (Electrochemical Drive Circuitry and Method); Ser. No. 10/833,194 (Methods and Apparatus for Determining Organic Component Concentrations in an Electrolytic Solution); Ser. No. 10/836,546 (Methods and Apparatuses for Monitoring Organic Additives in Electrochemical Deposition Solutions); Ser. No. 10/819,765 (Electrochemical Deposition Analysis System Including High-Stability Electrode); and Ser. No. 10/833,192 (One-Point Recalibration Method for Reducing Error in Concentration Measurements for an Electrolytic Solution). Each of the foregoing listed U.S. Patent Applications is incorporated herein by reference in its entirety for all purposes.

The time required to calibrate electroplating equipment and/or subsequent use of the same to measure and/or control the composition of Cu (and/or other metal) electroplating baths may be unsatisfactorily long and sometimes cumbersome. According to one embodiment of the present invention, it is desirable to provide a more efficient system and/or method for controlling the chemistry of a Cu electroplating bath in order to reduce the number of defective devices or components made.

Furthermore, in addition to the technology utilized in Defect Analysis Reduction Tool technology, other techniques have also been used to analyze bath chemistries in an offline manner. These include cyclic voltammetric stripping (CVS) or cyclic voltammetry, impedance analysis, UV-Vis spectroscopy and near IR spectroscopy.

While offline analysis of bath chemistries represent a significant improvement over no analysis at all (e.g., relying on bath usage rate to change baths out), they do not supply the real-time measurement, feedback and control that is desired in semiconductor manufacturing. By measuring bath chemistries on a real-time basis, quality control may be assured for each semiconductor wafer that is processed. When bath chemistry is found to be out of specification, several different steps might be taken. The process may be stopped, so that the chemistry can be manually adjusted, which prevents multiple semiconductor wafers from being ruined. Alternatively, the bath chemistry may be automatically adjusted as it is found, through the real-time measurement, to have drifted, potentially preventing any wafers from being mis-processed. Potentially, subsequent process steps can be adjusted to account for and compensate for the processing done during the wet chemistry step, resulting in better wafer processing results. Apparently in various instances, those facilities which already do employ real time analysis do so infrequently. This is the result of several factors including long analysis times (e.g., typically about 1.5 hours), the need for constant replenishment of reagents, the increased mean time between failure (MTBF) (as analysis frequencies increase due to the large number of moving parts on board MOS analyzers), and the increasing need for multiple data points to enhance the statitistical process control of the plating and/or polishing.

The foregoing problems are areas where improvements may be made. There is therefore a need to address one or more aspects of one or more of the areas in which improvements may be made—for example—those areas associated with plating and/or polishing. The present invention provides a cost effective way to collect and analyze large amounts of data from ECD and other semiconductor wet process tools, in order to identify both short and long term trends. This data may then be used to make decisions on how to control or to best utilize these tools and bath chemistries in order to minimize ECD or manufacturing defects, and to maximize wafer yield.

The analyzed data from the present invention may be used either to elucidate the compositional changes in the baths, or to phenomenologically predict the wafer yield based on previous results. Possible decision outcomes from the data analysis may include cessation of use of the tool, renewal or replacement of the baths, modification of process parameters, etc. Extraction of data from a large number of process tools via multiple sampling heads (and CPUs) will increase the statistics sample size, and potentially improve the quality and standardization of resulting decisions on how to operate the tools. This factory wide process sampling and analysis will become increasingly important as microelectronic device sizes decrease and wafer sizes increase, since each wafer will represent an increasing manufacturing investment.

The present invention will also result in wider proliferation of this real-time measurement and analysis capability, since the use of multiple sampling heads linked to a CPU will result in a lower cost per measurement point than previous single sensor systems would allow.

### SUMMARY OF THE INVENTION

The present invention relates to a sampling head, and/or an array including same for use in electrochemical deposition of various metal(s) on wafers or other substrates suitable for use in microelectronic devices or components thereof

The invention in various embodiments relates to a sampling head comprising:
(a) a sensor;
(b) data processing electronics; and
(c) a communications module.

In another aspect, the invention relates to a method for electroplating a substrate comprising utilizing a sample head of such type.

The invention in a further aspect relates to a method for wet processing a semiconductor wafer utilizing the sample head of such type.

Yet another aspect of the invention relates to an apparatus including the sample head of such type.

Other aspects, features and embodiments of the invention will be more fully apparent from the ensuing disclosure and appended claims.

### BRIEF DESCRIPTION OF THE DRAWINGS

FIG. 1 is a schematic of a defect analysis reduction tool system including sampling heads and a CPU, according to one embodiment of the present invention.

### DETAILED DESCRIPTION OF EMBODIMENTS OF THE INVENTION

Various embodiments of the present invention relate to building on Defect Analysis Reduction Tool technology by adding various features to it.

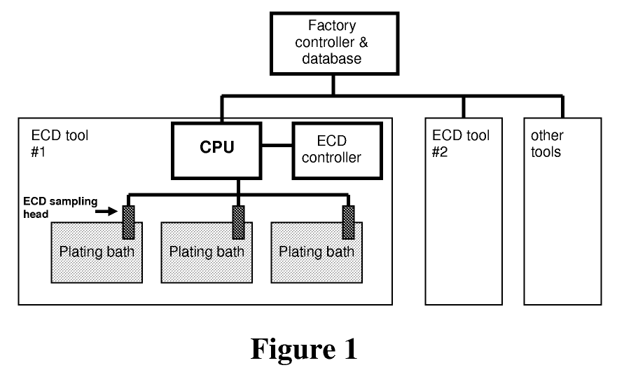

FIG. 1 is a schematic of a defect analysis reduction tool system including sampling heads and a CPU, according to one embodiment of the present invention. Note that CPU refers to a central processing unit. The CPU can process either raw or processed data that is collected at one or several bath locations in the ECD tool, and the CPU may be in communication with the tool controller and/or factory controller, in specific implementations.

In FIG. 1, a factory controller and database (e.g., a central semi-conductor factory controller and database) are connected to a CPU of ECD tool #1 and ECD tool #2 together with other tools. In the box labeled ECD tool #1, the CPU is connected to both the factory controller and database and to an ECD controller. The CPU is also connected to a plurality of plating baths. Each plating bath contains an ECD sampling head which may or may not be part of an array of sampling heads. It is envisioned to use either one sampling head alone or a plurality of sampling heads in an array of sampling heads. Typically, only one sampling head is used at a time from the array of sampling heads. However, according to an embodiment of the present invention, two or more sampling heads of the array could be used at the same time.

### Sampling Head

For example, a sampling head is created that is separate from some or all of the electronics and signal processing subsystems. Various features of a non-limiting exemplary sample head include, but are not limited to: (1) a sampling head that has a microelectrode-based measurement system in it, (2) able to sample wet baths in order to determine the efficacy of various additives; (3) the sampling head may in some embodiments consist of multiple electrodes; (4) the sampling head consisting of multiple electrodes may in some embodiments be constructed by process sequences used in microelectomechanical systems (MEMS) or Hybrid technologies; (5) each of the electrodes may be used either multiple times or, in some instances, only a single time; (6) in some embodiments calibration of the sampling head is not required outside of the process whereby the head is manufactured (e.g., that is, calibration before each measurement is not required in some embodiments); (7) the sampling head may include some or all of the of the relevant electronics and analysis software; (8) the sampling head may contain electrodes of various diameters, in order to access and sense different phenomena, via different boundary layer thicknesses; (9) these electrodes may be addressed either in parallel or serially in a particular measurement protocol, or may be uniquely selected for different applications or customer requirements. or for application diagnostics; (10) in some embodiments the sampling head will have an effective usable lifetime of greater than 1000 wafers; (11) in some embodiments the sampling head will have an effective usable lifetime of greater than 10,000 wafers; (12) furthermore, the sampling head may use geometries and features similar to those defined during fabrication of semiconductor devices; (13) the sampling head may also utilize the integration of an on board, multiplexed reference electrode array to enhance measurement stability in various aggressive environments; (14) the sampling head may be encapsulated in such a fashion so that only those electrodes being addressed are exposed to the solution being analyzed and those electrodes encapsulated may be in a gas or aqueous environment or in a pre calibrated solution environment; and (15) in other embodiments, electrocapillarity may be used on board the sampling head to bring defined amounts of sample to the active electrode(s).

Referring to FIG. 1, each plating bath contains an ECD sampling head which may or may not be part of an array of sampling heads. It is envisioned to use either one sampling head alone or a plurality of sampling heads in an array of sampling heads. Other types of sampling heads may be used.

Pursuant to an embodiment of the present invention, the sampling head comprises (a) a sensor, (b) data processing electronics, and (c) a communications module. The sensor of the sampling head may be a microelectrode or a microsensor. If it is a microelectrode, it may have a diameter of at least about 5 μm or have a diameter from about 5 μm to about 200 μm. Such a range of microelectrode sensor sizes will potentially allow greater sensitivity to a wider range of electrochemical phenomena than a single sensor could achieve. According to an embodiment of the present invention, the sensor head is a microelectrode or another type of microsensor suitable for making galvanostatic measurements in a liquid bath such as an ECD bath or a cleaning solution or some other type of liquid bath. The sensor may be partially or completely immersed in a plating or cleaning or other type of bath. Alternatively, the sensor may be exposed to the plating or cleaning or other type of bath by the use of a microcapillary attached to the sensor or dipped in the bath with one end in close proximity to the sensor sufficient for the sensor to permit the necessary galvanostatic measurements.

In accordance with another embodiment of the present invention, the sensor may be reusable. The sensor may also be a one-time use sensor having an effective useful life of at least about 1,000 wafers (e.g., useful for making the galvanostatic measurement during the plating of 1,000 wafers) or at least about 10,000 wafers. The sensor may also be disposable (not reusable). The sensor may also be a single sensor or may be a member of an array of sensors. The sensor may be such that it does not require calibration before making the requisite galvanostatic or other measurements as may be necessary to monitor the bath chemistry.

As with the sensor, the sampling head may be reusable or not. The sampling head may or may not require calibration before making the requisite galvanostatic or other measurements as may be necessary to monitor the bath chemistry. The sampling head may comprise software to aid in making the requisite measurements noted above. Instead of such software, the sampling head may contain hardware and/or electronics as a substitute for the software or in addition to the software. The sampling head may also comprise a multiplexed reference electrode or an array of same. The sampling head may be encapsulated with a suitable material to be removed before exposing the sampling head and/or sensor thereof to a bath (e.g., plating bath, or cleaning bath). The sampling head may contain an electrocapillary or the electrocapillary may be disposed in the relevant bath sufficient to expose the sensor to the bath for making the above-noted measurements (e.g., galvanostatic measurements or other relevant measurements needed to evaluate bath chemistry).

The sampling head may further comprise data storage electronics. The communication module of the sampling head may be such that it is suitable for transmitting or receiving (or both) analog communications, digital communications, fiber-optic communications, wireless communications, some other form of communications, or a combination thereof. Typically, communication may be (direct or indirect) between the sensor and/or sampling head to a CPU or controller or factory semi-conductor controller or a factory semi-conductor database, or some combination thereof.

The sampling head may contain multi-variate analysis software or hardware or electronics or a combination of the same for carrying out multi-variate analysis. Typically, the multi-variate analysis is conducted on the bath chemistry and the galvanostatic or other suitable measurements made at the sensor or the sampling head.

The sensor may be made by MEMS or standard microelectronic patterning techniques or both. The sensor associated with the sampling head may be a single sensor or a plurality of sensors. If a plurality of sensors, the sensors may be provided in an array of sensors.

Likewise, the sampling head may be a single sampling head or a plurality of sampling heads. If a plurality of sampling heads, the sampling heads may be provided in an array of sampling heads. The single sampling head or array of sampling heads may be suitable for communicating with a CPU or a factory semi-conductor controller or database or a combination thereof. The CPU, factory semi-conductor controller or database may communicate with a single sensor, a single sampling head, an array of sensors, an array of sampling heads or a combination of the same.

The sensor and/or an array of the same may be suitable for compete or partial immersion in a bath or exposure to the liquid of a given bath or cleaning solution and yet be robust enough to permit/make or conduct the requisite galvanostatic or other measurements noted above sufficient to monitor (e.g., continuous real time or at set or non-set time intervals) bath chemistry. Such a sensor or array should be robust enough as noted in a ECD plating bath, an electroless plating bath, a CMP plating bath, or a combination thereof.

The sampling head, the sensor or an array of the same, respectively, may be disposed in a wafer processing bath, in a material reservoir, at an exit drain of a wafer processing bath, or in plumbing to or from such bath, reservoir or a tank containing one or more of the above noted baths (e.g., plating bath, or CMP bath or ECD bath) or cleaning solutions or a combination thereof.

The sample head, the sensor or an array of the same, respectively, may be suitable for communicating with a wafer processing tool controller, a central semi-conductor factory controller or a database associated with same or a combination of controller(s) and database(s)

Typically, only one sampling head is used at a time from the array of sampling heads. However, according to an embodiment of the present invention, two or more sampling heads of the array could be used at the same time.

### Multi-Variate Analysis and Data

Galvanostatic measurement(s) or other data may be fully or partially processed by a central processing unit (CPU). In some embodiments the data measured by the sampling head is electronically transferred (either as raw data or in reduced or processed format) to a central processing unit where analysis is made on the data.

This analysis may include multi-variate analysis (MVA). The data may be transferred by any electronic means, including analog communication, digital communication, fiber-optic communication, wireless communication, etc. The data may be stored on the central processing unit in either raw or reduced form. The central processing unit may further communicate to either the controller for the wet bath tool or to a controller for the semiconductor factory.

### Plating Baths

One or more embodiments of the present invention may be applied or used in conjunction with a variety of plating baths. For example, embodiments of the present invention may be used with plating baths including, but not limited to: (1) any wet chemical baths where the efficacy of bath additives can be monitored by electrochemical techniques such as galvanostatic analysis; (2) in general, any wet chemical baths where the efficacy of additives can be analyzed when they are in the range of concentration from about 0.1 ppb to about 20% (by weight); (3) electrochemical plating baths (ECP) used in semiconductor fabrication to deposit metals such as copper, gold, cobalt, etc.; and (4) chemical mechanical polishing baths (CMP) used in semiconductor fabrication to planarize either dielectric or metallic films.

### Sampling Head Placement

According to one or more embodiments of the present invention, the sensor head(s) may be placed in one or more locations. For example, the sensor head may be placed at any point where it has access to the plating bath, which includes but is not limited to: (1) the recirculation tank, (2) the exit drain of the plating cell, and (3) an access point in the plating cell specific to this device, such as a drain point or bypass loop.

Other non-limiting embodiments of the present invention are as described in the appended claims. See, for example, the method and apparatus claims appended hereto.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

1. A sampling head comprising:
(a) a sensor;
(b) data processing electronics; and
(c) a communications module.

2. The sampling head of claim 1, wherein said sensor includes a microelectrode having an electrode diameter of at least about 5 μm or from about 5 μm to about 200 μm.

3. The sampling head of claim 1, wherein said sensor includes a microelectrode adapted for making galvanostatic measurements in a liquid bath.

4. The sampling head of claim 1, wherein said sensor is one member of an array of a plurality of sensors.

5. The sampling head of claim 1, wherein said sensor is reusable.

6. The sampling head of claim 1, wherein said sensor is not reusable.

7. The sampling head of claim 1, wherein said sampling head does not require calibration.

8. The sampling head of claim 1, further comprising software.

9. The sampling head of claim 4, wherein said array of said plurality of sensors comprises sensors that are addressed in parallel or serial format or both.

10. The sampling head of claim 1, wherein said sampling head has an effective useful life of at least about 1,000 wafers.

11. The sampling head of claim 10, wherein said sampling head has said effective useful life of at least about 10,000 wafers.

12. The sampling head of claim 1, wherein said sensor is made by microelectromechanical systems (MEMS) or by microelectronic patterning techniques or both.

13. The sampling head of claim 4 further comprising an array of multiplexed reference electrodes.

14. The sampling head of claim 1, wherein said sampling head is encapsulated.

15. The sampling head of claim 1 further comprising an electrocapillary.

16. The sampling head of claim 1 further comprising multi-variate analysis software.

17. The sampling head of claim 1 further comprising data storage electronics.

18. The sampling head of claim 1, wherein said communications module is adapted for transmitting or receiving analog communications, digital communications, fiber-optic communications, wireless communications or a combination thereof.

19. The sampling head of claim 1 adapted for communicating with a central processing unit.

20. The sampling head of claim 4, wherein said plurality of sensors are adapted for communicating with a central processing unit.

21. The sampling head of claim 1, wherein said sampling head is one member of an array of a plurality of sampling heads.

22. The sampling head of claim 21, wherein said plurality of sampling heads are adapted for communicating with a central processing unit.

23. The sampling head of claim 21, wherein said central processing unit communicates with a plurality of arrays of sampling heads.

24. The sampling head of claim 1, wherein said sensor is adapted for partial or complete immersion in a plating bath.

25. The sampling head of claim 24, wherein said plating bath comprises an electrochemical deposition (ECD) plating bath, or an electroless plating bath.

26. The sampling head of claim 1, wherein said sensor is suitable for partial or complete immersion in a cleaning solution.

27. The sampling head of claim 1 disposed in a wafer processing bath, in a recirculation tank, in a material reservoir, at an exit drain of said wafer processing bath, or in plumbing of said bath, said tank or said reservoir.

28. The sampling head of claim 22, wherein said central processing unit is adapted for communicating with a wafer processing tool controller, or a central semi-conductor factory controller.

29. The sampling head of claim 4, wherein sensors in said array of said plurality of sensors that are operated in a parallel or serial sensing mode, or both.

30. The sampling head of claim 1, wherein said sampling head contains self-test or auto-calibration routines.

31. A method for processing a substrate, selected from the processes of electroplating a substrate and wet processing a semiconductor wafer, comprising utilizing the sample head of claim 1.

32. (canceled)

33. An apparatus comprising the sample head of claim 1.

34. An electrochemical deposition plating system: comprising an electrochemical plating bath; an electrochemical deposition sampling head including at least one sensor and data processing electronics; a communication's module; a central processing unit; and an electrochemical deposition controller.
